(19) United States
(12) Patent Application Publication
(10) Pub. No.: US 2023/0025661 A1
(43) Pub. Date: Jan. 26, 2023

(54) Amine-Substituted 2-Amino-Ethan-1-Olyl Polymers, Polyimides, Articles, and Methods

(71) Applicant: Essex Furukawa Magnet Wire USA LLC, Fort Wayne, IN (US)

(72) Inventor: Scott Jolley, Fort Wayne, IN (US)

(21) Appl. No.: 17/550,750

(22) Filed: Dec. 14, 2021

Related U.S. Application Data
(62) Division of application No. 17/358,761, filed on Jun. 25, 2021, now abandoned.

(51) Int. Cl. C09D 179/08; C08G 73/12; H01B 3/30

(52) U.S. Cl. CPC C09D 179/085; C08G 73/128; H01B 3/306

(57) ABSTRACT

Amine-substituted copolymers that may include an amine-substituted 2-amino-ethan-1-ol moiety. Polyamic acids and polyimides, which may be formed by contacting an amine substituted copolymer with a dianhydride, or a dianhydride and a diamine. Articles, such as wires, having a surface on which a polyimide is disposed. Methods for forming polymers.

### CROSS-REFERENCE TO RELATED APPLICATIONS

This application claims priority U.S. patent application Ser. No. 17/358,761, filed Jun. 25, 2021, which is incorporated herein by reference.

### TECHNICAL FIELD

Embodiments of this disclosure relate generally to amine-substituted copolymers, including amine-substituted 2-amino-ethan-1-olyl copolymers, polyimides, methods, and articles, such as a wire, that include insulation formed from a corona resistant polyimide.

### BACKGROUND

Magnet wire, also referred to as winding wire or magnetic winding wire, is utilized in a wide variety of electric machines and devices, such as inverter drive motors, motor starter generators, transformers, etc. Magnet wire typically includes polymeric enamel insulation formed around a central conductor. The enamel insulation is typically formed by applying a varnish onto the magnet wire and curing the varnish in an oven to remove solvents, thereby forming a thin enamel layer. This process is repeated until a desired enamel build or thickness has been attained.

Polymeric materials utilized to form enamel layers are intended for use under certain maximum operating temperatures. Additionally, electrical devices may be subject to relatively high voltage conditions that may break down or degrade the wire insulation. For example, an inverter may generate variable frequencies that are input into certain types of motors, and the variable frequencies may exhibit steep wave shapes that cause premature motor winding failures.

As a further example, modern high voltage, high current motors, such as those used in electric automobiles, can generate strong corona fields. These strong fields can degrade wire enamels.

There remains a need for materials, including wire enamels, that perform better in strong corona fields, including materials with reduced crystallinity and/or less solution viscosity.

### BRIEF SUMMARY

Provided herein are compositions that may have an improved partial discharge inception voltage (PDIV). The PDIVs of enamels described herein may be about 5% to about 10% greater than known enamels. Compositions provided herein also may be less viscous, prepared in relatively high concentrations, or a combination thereof. The compositions may include an amine-substituted polymer or compound that is reacted with a dianhydride to form a polyamic acid. The amine-substituted polymer or compound increases the “crosslinked” character of the compositions, which may increase the compositions' amorphic nature and decrease crystallinity, therefore increasing the free volume of the polymer products.

Provided herein are polymers or compounds that may be substituted with amines, and polyamic acids or polyimides that may be formed with the polymers or compounds. Also provided herein are methods for forming polyamic acids or polyimides, and articles having a surface on which a polyamic acid/polyimide is disposed.

In one aspect, amine-substituted polymers and amine-substituted compounds are provided. In some embodiments, the polymers or compounds include one or more monomers of formula (I), a structure of formula (A), or a structure of formula (B):

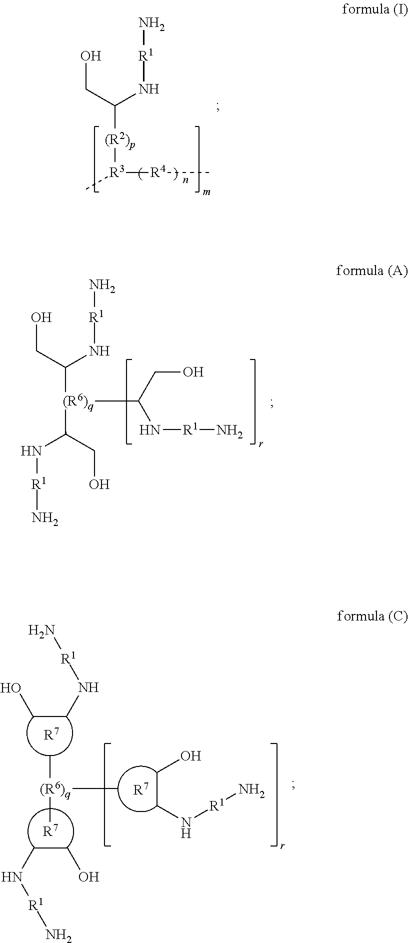

wherein R¹, R², R³, R⁴, and R⁶, independently, are a C₁-C₃₀ hydrocarbyl; R⁷ is a monocyclic or polycyclic C₁-C₃₀ hydrocarbyl; m is an integer from 2 to 1,000,000, 2 to 750,000, 2 to 500,000, 2 to 250,000, 2 to 100,000, or 2 to 10,000; n, p, and q, independently, are 0 or 1; and r is an integer from 0 to 6.

In another aspect, polymers, including polyimides, are provided. In some embodiments, the polyimides have a structure according to formula (II), formula (III), or formula (IV):

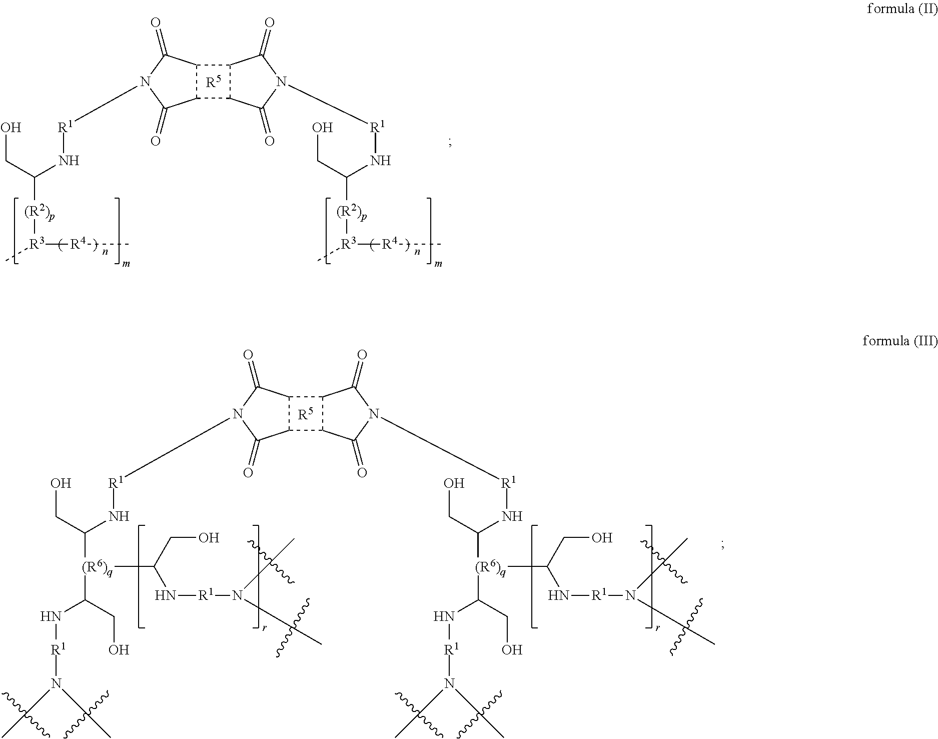

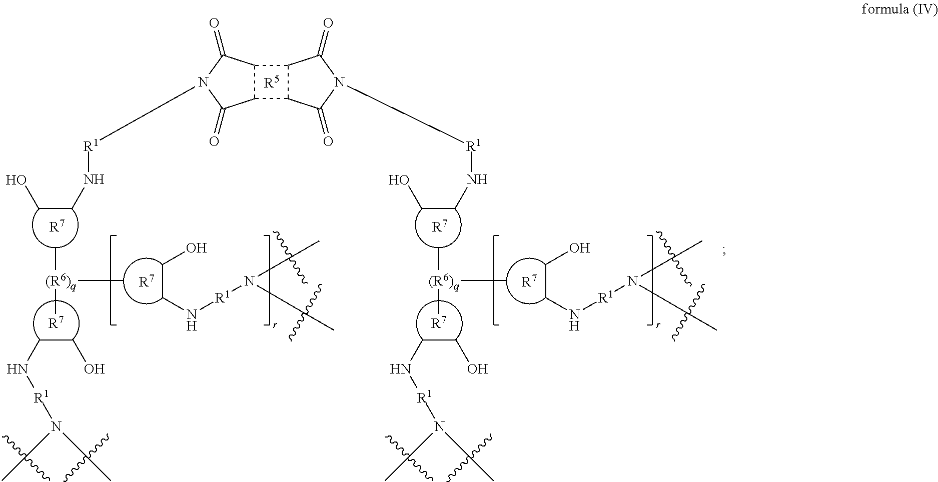

wherein R¹, R², R³, R⁴, and R⁶, independently, are a C₁-C₃₀ hydrocarbyl; R⁵ and R⁷, independently, are a monocyclic or polycyclic C₁-C₃₀ hydrocarbyl; m is an integer from 2 to 1,000,000, 2 to 750,000, 2 to 500,000, 2 to 250,000, 2 to 100,000, or 2 to 10,000; n, p, and q, independently, are 0 or 1; and r is an integer from 0 to 6.

In yet another aspect, articles, such as wires, are provided. In some embodiments, the articles, such as wires, include a conductor; and at least one layer of a polymeric enamel insulation adjacent the conductor. The polymeric enamel insulation may include a polyimide of one or more of formula (II), formula (III), or formula (IV).

In a still further aspect, methods of forming polymers or compounds are provided. In some embodiments, the methods include providing a polymer comprising a first monomer, the first monomer comprising a 2-((amino-C₁-C₃₀ hydrocarbyl)amino)ethan-1-olyl moiety; contacting the polymer and a dianhydride to form a polyamic acid; and heating the polyamic acid at a temperature effective to form the polyimide.

Additional aspects will be set forth in part in the description which follows, and in part will be obvious from the description, or may be learned by practice of the aspects described herein. The advantages described herein may be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

FIG. 1A depicts a cross-sectional view of an embodiment of a magnet wire that includes a surface on which a layer including a polyimide is disposed.

FIG. 1B depicts a cross-sectional view of an embodiment of a magnet wire that includes a surface on which a layer including a polyimide is disposed.

### DETAILED DESCRIPTION

Provided herein are polymers and compounds, including polymers and compounds that are amine-substituted. In some embodiments, the polymers include one or more monomers of formula (I), and the compounds have a structure according to formula (A) or formula (B):

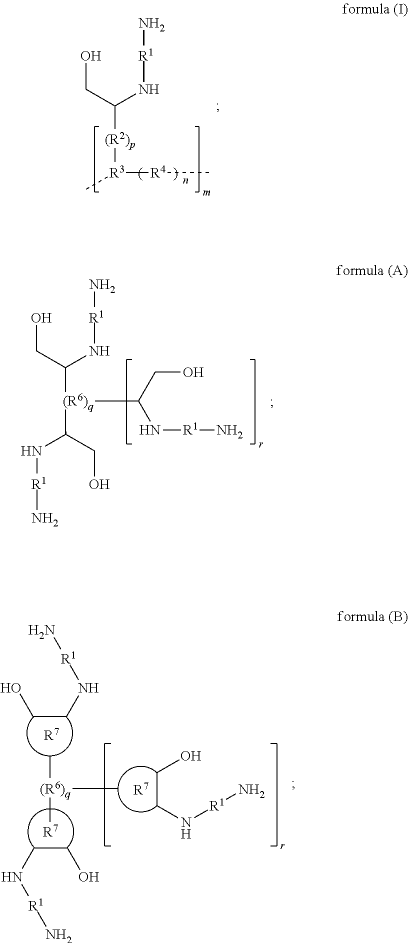

wherein R¹, R², R³, R⁴, and R⁶, independently, are a C₁-C₃₀hydrocarbyl; R⁷ is a monocyclic or polycyclic C₁-C₃₀ hydrocarbyl; m is an integer from 2 to 1,000,000, 2 to 750,000, 2 to 500,000, 2 to 250,000, 2 to 100,000, or 2 to 10,000; n, p, and q, independently, are 0 or 1; and r is an integer from 0 to 6. The copolymers of formula (I), formula (A), or formula (B) may include any end groups. The end groups may, for example, include a C₁-C₃₀ hydrocarbyl.

In some embodiments, R₁ has a structure according to any of formulas (a)-(x), including substituted derivatives thereof:

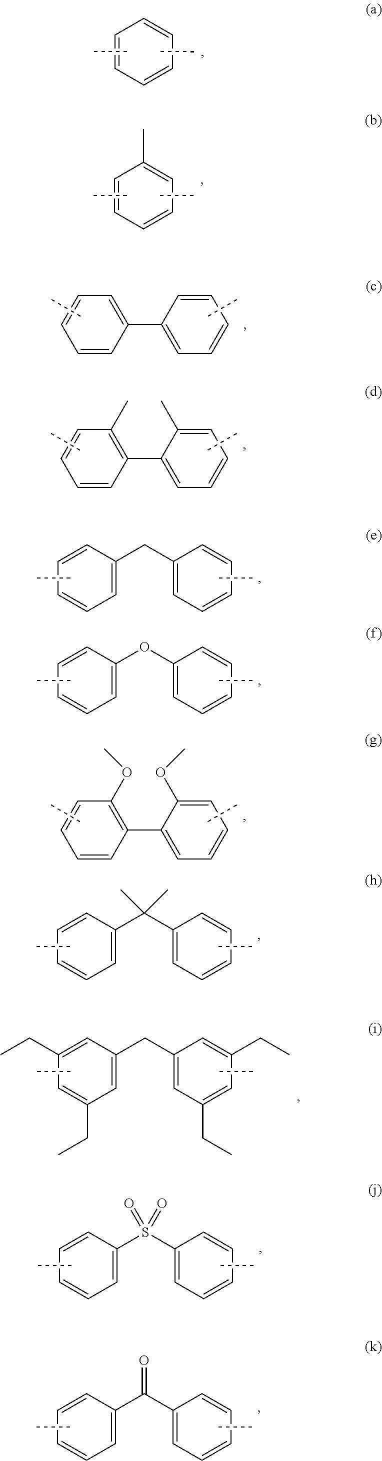

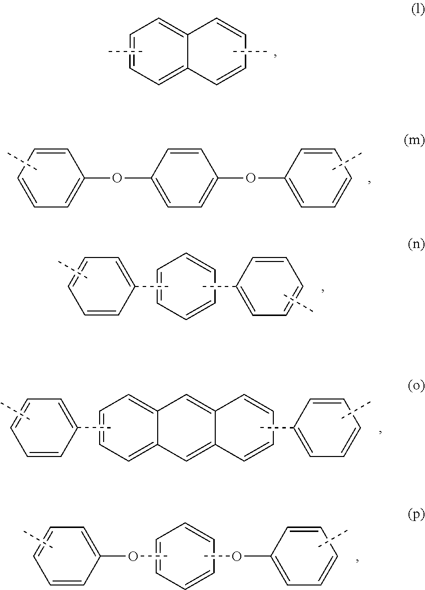

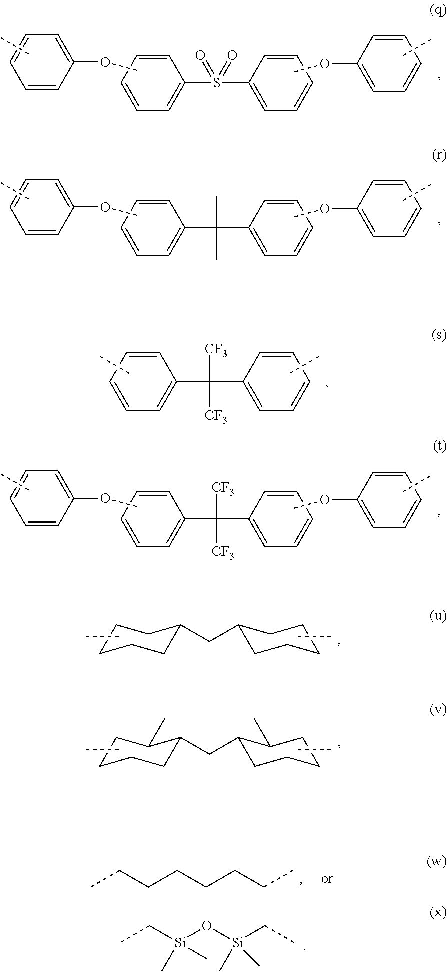

The dotted bond lines in the foregoing structures indicate a location, or possible location, of a bond between the foregoing structures and the nitrogen atoms bonded to R¹. R¹, for example, may be an unsubstituted oxy-diphenyl:

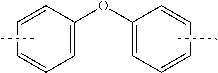

and the copolymer is of formula (Ia):

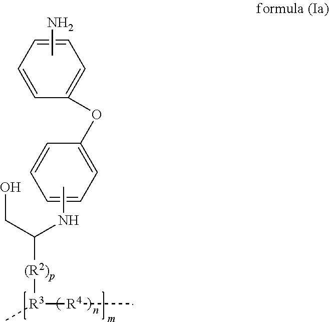

In some embodiments, the polymer includes one or more monomers of formula (I), wherein p is 1, R² is an oxygen-substituted C₁ hydrocarbyl having the structure—OCH₂—, R³ is an unsubstituted aryl C₆ hydrocarbyl, n is 1, R⁴ is an unsubstituted C₁ hydrocarbyl, and the polymer includes one or more monomers of formula (Ib):

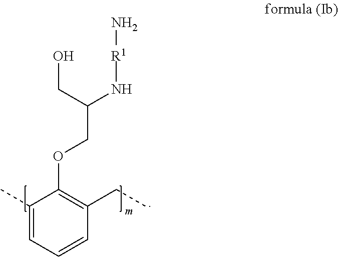

In some embodiments, the polymer includes one or more monomers of formula (I), wherein R¹ is an unsubstituted oxy-diphenyl, p is 1, R² is an oxygen-substituted C₁ hydrocarbyl having the structure—OCH₂—, R³ is an unsubstituted aryl C₆ hydrocarbyl, n is 1, R⁴ is an unsubstituted C₁ hydrocarbyl, and the polymer includes one or more monomers of formula (Ic) or formula (Id):

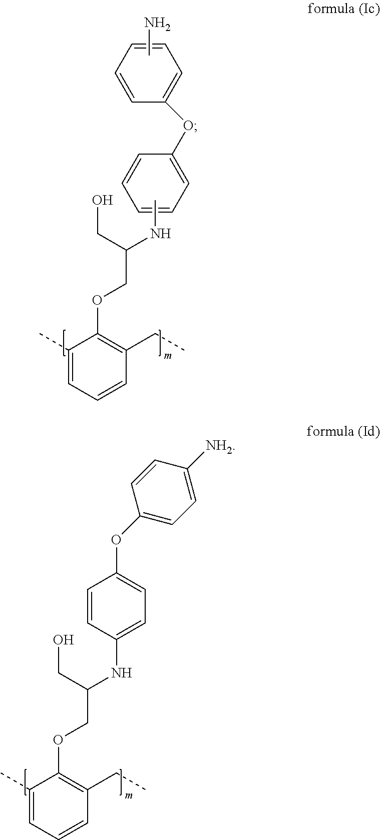

When a compound is of formula (A) or formula (B), the compounds may read on a product obtained by contacting a diamine compound with precursor compound including two or more epoxy moieties, as described herein. For example, a precursor compound may include TACTIX® 742 tri-epoxy (Huntsman, USA), and the compound of formula (A) may have a structure according to formula (Aa), as described herein. As a further example, a precursor compound may include butadiene diepoxide (i.e., diepoxybutane), and the amine-substituted compound may have a structure according to formula (A), wherein q is 0 and r is 0. As a still further example, a precursor compound may include 3,4-epoxycyclohexylmethyl 3,4-epoxycyclohexanecarboxylate, and the amine-substituted compound may have a structure according to formula (Bb), as described herein.

In some embodiments, the compound is of formula (A), wherein q is 1, r is 1, and R⁶ is a tris(4-methoxyphenyl)methane moiety, and the compound has a structure of formula (Aa):

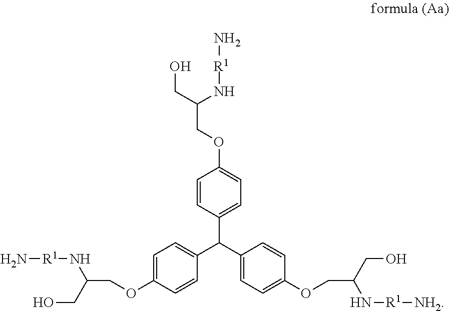

In some embodiments, the compound is of formula (B), wherein q is 1, r is 0, R⁷ is an unsubstituted C₆ hydrocarbyl, R⁶ is a C₂ hydrocarbyl comprising an ester moiety, and the compound has a structure of formula (Ba):

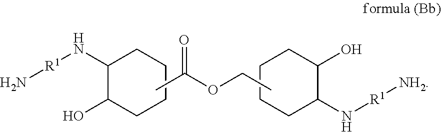

### Polyimide Polymers

Also provided herein are polymers, including polyamic acids and polyimides. In some embodiments, the polyimides are of formula (II), formula (III), or formula (IV):

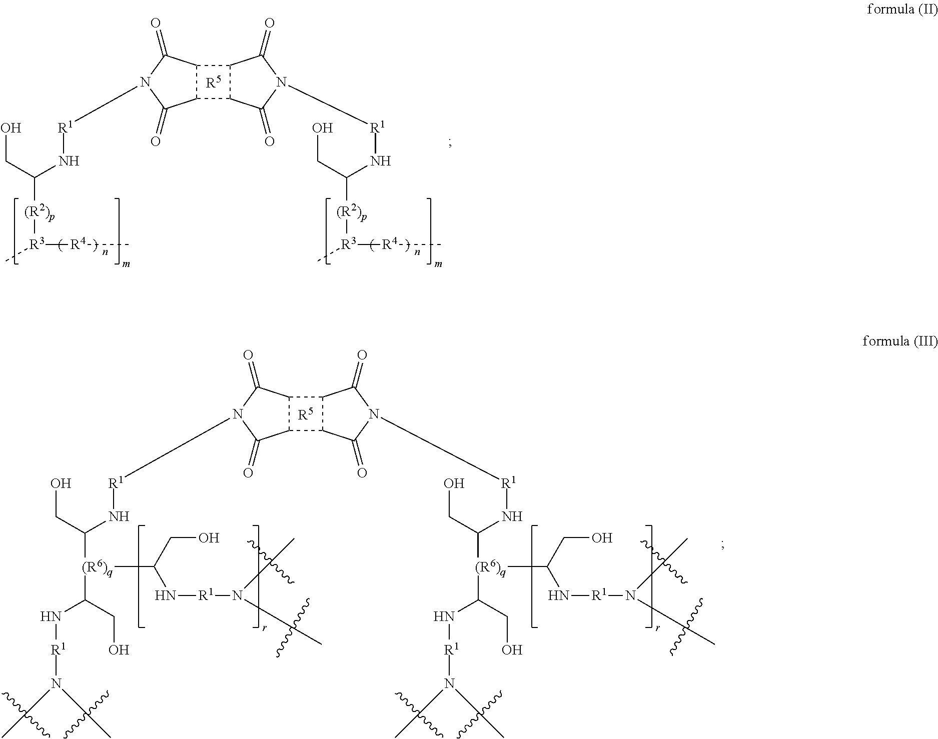

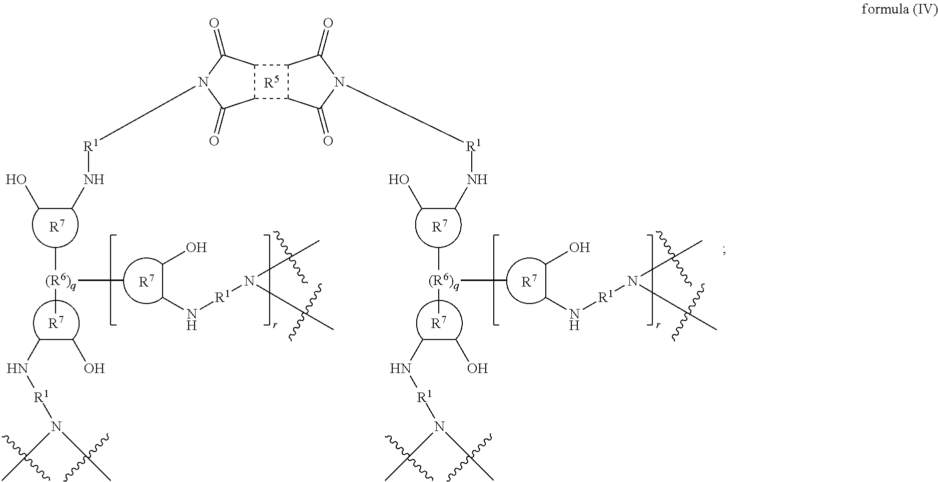

wherein R¹, R², R³, R⁴, and R⁶, independently, are a C₁-C₃₀ hydrocarbyl; R⁵ and R⁷, independently, are a monocyclic or polycyclic C₁-C₃₀ hydrocarbyl; m is an integer from 2 to 1,000,000, 2 to 750,000, 2 to 500,000, 2 to 250,000, 2 to 100,000, or 2 to 10,000; n, p, and q, independently, are 0 or 1; and r is an integer from 0 to 6.

In some embodiments, p is 1, R² is an oxygen-substituted C₁ hydrocarbyl having the structure—OCH₂—, R³ is an unsubstituted aryl C₆ hydrocarbyl, n is 1, R⁴ is an unsubstituted C₁ hydrocarbyl, and the polymer comprises one or more monomers of formula (IIa):

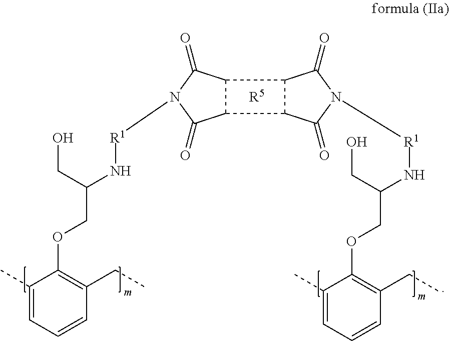

In some embodiments, R⁵ of formula (II), formula (III), or formula (IV) is (i) an unsubstituted benzene moiety; (ii) an unsubstituted biphenyl moiety; (iii) an unsubstituted benzophenonyl moiety; (iv) an unsubstituted oxy-diphenyl moiety; and (v) an unsubstituted naphthalenyl moiety.

### Articles

Articles also provided herein, including articles having a surface on which a polymer described herein is disposed. The articles may include a conductive article, such as a wire. The wire may include a conductor; and at least one layer of a polymeric enamel insulation adjacent the conductor, wherein the polymeric enamel insulation includes a polyimide as described herein, such as a polyimide of formula (II), formula (III), or formula (IV).

In some embodiments, filler material is added to a polyimide polymer. The filler material may include a blend of at least titanium oxide (TiO₂) and silica oxide (SiO₂). A blend may additionally include other suitable materials as desired, such as chromium oxide (CrO₂). Filler material may be added to a polyimide at any suitable ratio. For example, in some embodiments, a total amount of filler in a filled polyimide enamel insulation layer is from about 10% to about 25%, by weight.

In some embodiments, one or more additives is added to a polyimide. The one or more additives may be used alone or in combination with a filler material. At least one additive may include an amine moiety reacted with an aldehyde. For example, a CYMEL® resin material (Allnex, GmbH, Germany) may be utilized as an additive.

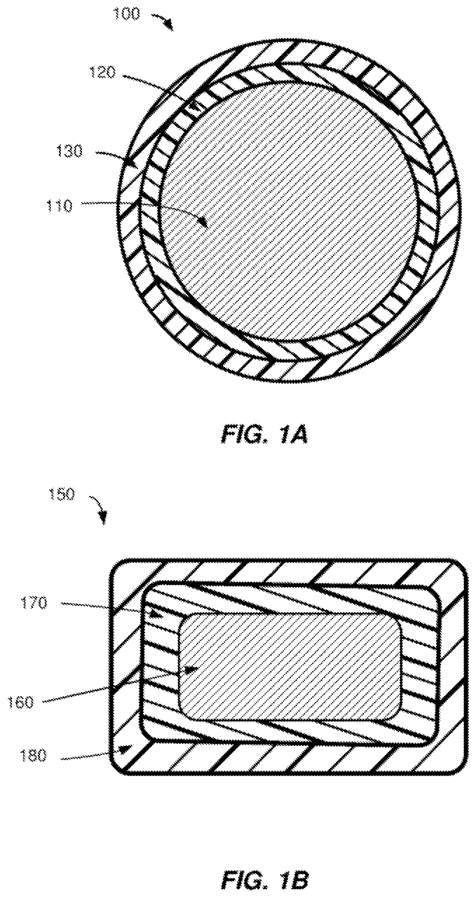

FIG. 1A depicts a cross-sectional end-view of an embodiment of a round magnet wire 100, which includes a conductor 110 coated with enamel insulation. Any suitable number of enamel layers may be used. As shown at FIG. 1A, a plurality of layers of enamel insulation, including a base coat 120 and a topcoat 130, is formed around the conductor 110. In some embodiments, a single layer of enamel insulation is used. In some embodiments, more than two layers of enamel insulation are used. One or more of the enamel layers, such as the base coat 120 and/or top coat 130 of FIG. 1A, may include an inorganic filler, and the filler may include a combination of silica oxide and titanium oxide.

FIG. 1B depicts a cross-sectional end-view of an embodiment of a substantially rectangular magnet wire 150, which includes a conductor 160 coated with enamel insulation. FIG. 1B depicts a plurality of layers of enamel insulation, which includes a base coat 170 and a topcoat 180 formed around the conductor 160. In some embodiments, a single layer of enamel insulation is used. In some embodiments, more than two layers of enamel insulation are used. Further, one or more of the enamel layers may include a suitable inorganic filler, and the filler may include a combination of silica oxide and titanium oxide. The round wire 100 of FIG. 1A is described in greater detail below; however, it should be appreciated that various components of the rectangular wire 150 of FIG. 1B may be similar to those described for the round wire 100 of FIG. 1A.

The conductor 110 may be formed from a wide variety of suitable materials or combinations of materials. For example, the conductor 110 may be formed from copper, aluminum, annealed copper, oxygen-free copper, silver-plated copper, nickel plated copper, copper clad aluminum (“CCA”), silver, gold, a conductive alloy, a bimetal, or any other suitable electrically conductive material. Additionally, the conductor 110 may be formed with any suitable cross-sectional shape, such as the circular or round cross-sectional shape depicted at FIG. 1A. In some embodiments, a conductor 110 may have a rectangular (as shown, for example, at FIG. 1B), square, elliptical, oval, or any other suitable cross-sectional shape. A conductor may have corners that are rounded, sharp, smoothed, curved, angled, truncated, or otherwise formed. The conductor 110 may also be formed with any suitable dimensions, such as any suitable gauge, diameter, height, width, cross-sectional area, etc.

Any number of layers of enamel, such as the base coat 120 and topcoat 130 of FIG. 1A, may be formed around the conductor 110. An enamel layer is typically formed by applying a polymeric varnish, which may include a polyamic acid, to the conductor 110 and then baking the conductor 110 in a suitable enameling oven or furnace. The polymeric varnish typically includes a thermosetting polymeric material or resin suspended in one or more solvents. A thermosetting or thermoset polymer is a material that may be irreversibly cured from a soft solid or viscous liquid (e.g., a powder, etc.) to an insoluble or cross-linked resin. Thermosetting polymers typically cannot be melted for application via extrusion as the melting process will break down or degrade the polymer. Thus, thermosetting polymers are suspended in solvents to form a varnish that can be applied and cured to form enamel film layers. Following application of a varnish, solvent is removed as a result of baking or other suitable curing, thereby leaving a solid polymeric enamel layer. A plurality of layers of enamel may be applied to the conductor 110 in order to achieve a desired enamel thickness or build (e.g., a thickness of the enamel obtained by subtracting the thickness of the conductor and any underlying layers). Each enamel layer may be formed utilizing a similar process. In other words, a first enamel layer may be formed, for example, by applying a suitable varnish and passing the conductor through an enameling oven.

A second enamel layer may subsequently be formed by applying a suitable varnish and passing the conductor through either the same enameling oven or a different enameling oven. Indeed, an enameling oven may be configured to facilitate multiple passes of a wire through the oven. As desired in various embodiments, other curing devices may be utilized in addition to or as an alternative to one or more enameling ovens. For example, one or more suitable infrared light, ultraviolet light, electron beam, and/or other curing systems may be utilized.

As desired, each layer of enamel, such as the base coat 120 and the topcoat 130, may be formed with any suitable number of sublayers. For example, the base coat 120 may include a single enamel layer or, alternatively, a plurality of enamel layers or sublayers that are formed until a desired build or thickness is achieved. Similarly, the topcoat 130 may include one or a plurality of sublayers. Each layer of enamel and/or a total enamel build may have any desired thickness, such as a thickness of approximately 0.0002, 0.0005, 0.007, 0.001, 0.002, 0.003, 0.004, 0.005, 0.006, 0.007, 0.008, 0.009, 0.010, 0.012, 0.015, 0.017, or 0.020 inches, a thickness included in a range between any two of the aforementioned values, and/or a thickness included in a range bounded on either a minimum or maximum end by one of the aforementioned values.

### Methods

Also provided herein are methods of forming polymers, including polyamic acids and polyimides. In some embodiments, the methods include providing (i) a polymer comprising a first monomer, the first monomer including a 2-((amino-C₁-C₃₀ hydrocarbyl)amino)ethan-1-olyl moiety, or (ii) a compound comprising two or more 2-((amino-C₁-C₃₀ hydrocarbyl)amino)ethan-1-olyl moieties. The 2-((amino-C₁-C₃₀ hydrocarbyl)amino)ethan-1-olyl moiety may have a structure according to formula (i), formula (ii), formula (iii), or a combination thereof, wherein R¹ is a C₁-C₃₀ hydrocarbyl, as described herein:

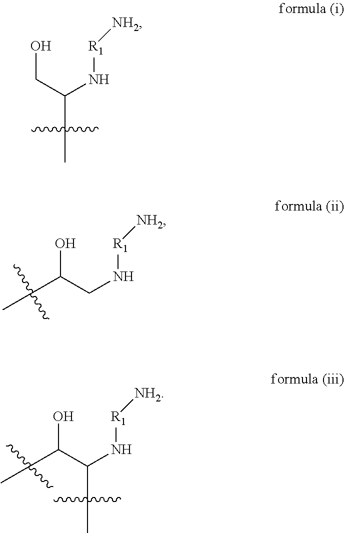

The providing of the polymer including a first monomer or the compound including two or more 2-((amino-C₁-C₃₀ hydrocarbyl)amino)ethan-1-olyl moieties may include providing a precursor polymer or a precursor compound, the precursor polymer comprising a monomer comprising an epoxy moiety, and the precursor compound comprising two or more epoxy moieties; and contacting the precursor polymer and a diamine to form the polymer, or contacting the precursor compound and a diamine to form the polymer. In some embodiments, the precursor polymer is contacted with a molar excess of the diamine. The diamine, in some embodiments, has a structure according to any of formulas (a)-(x), wherein the formula is di-amino substituted at possible locations indicated by the dotted lines.

In some embodiments, the precursor compound or the precursor polymer is selected from a novolac epoxy. A novolac epoxy may include any of those described herein. In some embodiments, the novolac epoxy resin includes one or more monomers of the following formula:

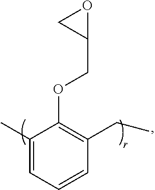

wherein r is an integer from 1 to 100.

As a further example, a novolac epoxy may include dicyclopentadiene linkages, such as those depicted in the following example of a novolac epoxy, wherein “a” is 1 to 30:

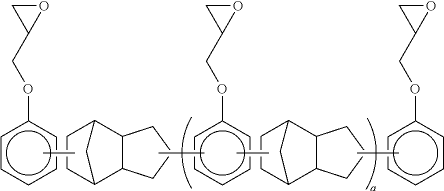

In some embodiments, the precursor compound or the precursor polymer is selected from a diepoxy. Non-limiting examples of a diepoxy include butadiene dioxide; 1,2,5,6-diepoxyhexane; diglycidyl ether; diglycidyl ether of 1,3-butanediol; 1,8-bis(2,3-epoxypropoxy) octane; 1,4-bis(2,3-epoxypropoxy) cyclohexane; 1,4-bis(3,4-epoxybutoxy)-2-chlorocyclohexane; the di(epoxycyclohexanecarboxylates) of aliphatic diols exemplified by the bis(3,4-epoxycyclohexanecarboxylate) of 1,5-pentanediol, 3-methyl-1,5-pentanediol, 2-methoxymethyl-2,4-dimethyl-1,5-pentanediol, ethylene glycol, 2,2-diethyl-1,3-propanediol, 1,6-hexanediol and 2-butene-1,4-diol; the oxyalkylene glycol epoxycyclohexanecarboxylates exemplified by bis(2-ethylhexyl-4,5-epoxycyclohexane-1,2-dicarboxylate) of dipropylene glycol, bis(3,4-epoxy-6-methylcyclohexanecarboxylate) of diethylene glycol and bis(3,4-epoxycyclohexanecarboxylate) of triethylene glycol; the epoxycyclohexylalkyl epoxycyclohexanecarboxylates exemplified by 3,4-epoxycyclohexylmethyl 3,4-epoxycyclohexanecarboxylate, 3,4-epoxy-1-methylcyclohexylmethyl 3,4-epoxy-1-methylcyclohexanecarboxylate, 3,4-epoxy-2-methylcyclohexylmethyl 3,4-epoxy-2-methylcyclohexanecarboxylate, 3,4-epoxy-6-methylcyclohexylmethyl 3,4-epoxy-6-methylcyclohexanecarboxylate, (1-chloro-3,4-epoxycyclohexan-1-yl) methyl 1-chloro-3,4-epoxycyclohexanecarboxylate, (1-bromo-3,4-epoxycyclohexan-1-yl) methyl 1-bromo-3,4-epoxycyclohexanecarboxylate and (1-chloro-2-methyl-4,5-epoxycyclohexan-1-yl) methyl 1-chloro-2-methyl-4,5-epoxycyclohexanecarboxylate; epoxycyclohexylalkyl dicarboxylates exemplified by bis(3,4-epoxycyclohexylmethyl) pimelate and oxalate and bis(3,4-epoxy-6-methylcyclohexylmethyl) maleate, succinate, sebacate and adipate; epoxycyclohexylalkyl phenylene-dicarboxylates exemplified by bis(3,4-epoxycyclohexylmethyl) terephthalate; bis(3,4-epoxy-6-methylcyclohexylmethyl) diethylene glycol ether; vinyl cyclohexene dioxide; diepoxide of dicyclohexene; dicyclopentadiene dioxide; bis(2,3-epoxycyclopentyl) ether; glycidyl 2,3-epoxycyclopentyl ether; 2,3-epoxycyclopentyl 2-methylglycidyl ether; 1,2,5,6-diepoxy-3-hexyne; 1,3-bis(2,3-epoxypropoxy)benzene; 1,4-bis(2,3-epoxypropoxy) benzene; 1,3-bis(4,5-epoxypentoxy)-5-chlorobenzene; 4,4′-bis(2,3-epoxypropoxy) diphenylether; 2,2-bis(2,3-epoxypropoxyphenyl) methane; 2,2-bis [p-(2,3-epoxypropoxy) phenyl] propane, i.e., the diglycidyl ether of bisphenol A; and quinoline diepoxide.

In some embodiments, the precursor compound includes a triepoxy. The triepoxy may include a tri-phenyl core. An example of a triepoxy is TACTIX® 742 triepoxy (Huntsman, USA). In some embodiments, the precursor compound includes a tetraepoxy. Tetraepoxy may include a tetra-phenyl core. An example of a tetraepoxy is Resin XB 4399-3 tetraepoxy (Huntsman, USA).

In some embodiments, the methods also include contacting the polymer and a dianhydride to form a polyamic acid. In some embodiments, the methods include contacting the compound and a dianhydride to form a polyamic acid.

In some embodiments, the dianhydride is selected from the group consisting of

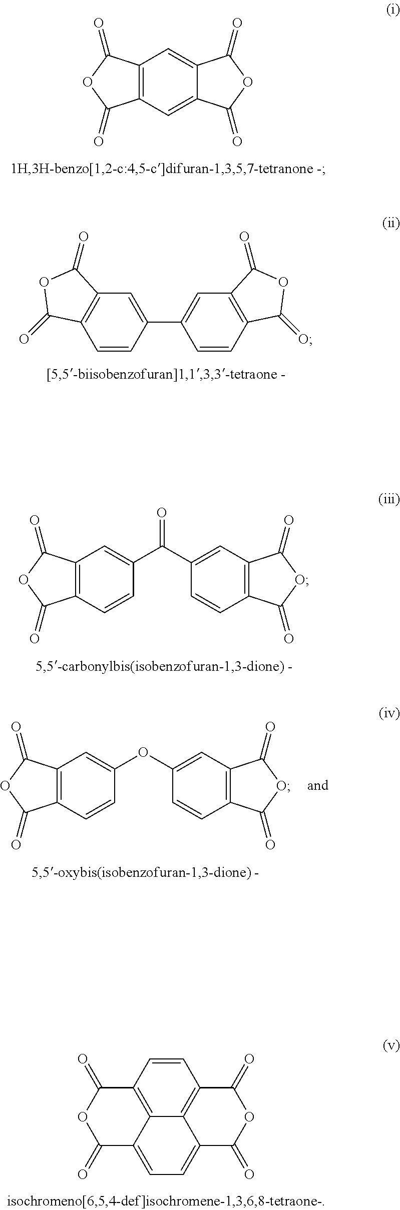 [SMILES: O=c1oc(=O)c2cc3c(=O)oc(=O)c3cc12 ; O=C1OC(=O)c2cc(-c3ccc4c(c3)C(=O)OC4=O)ccc21 ; O=C(c1ccc2c(c1)C(=O)OC2=O)c1ccc2c(c1)C(=O)OC2=O ; O=C1OC(=O)c2cc(Oc3ccc4c(c3)C(=O)OC4=O)ccc21 ; O=C1OC(=O)c2ccc3c4c(ccc1c24)C(=O)OC3=O]

In some embodiments, the methods also include heating the polyamic acid at a temperature effective to form the polyimide. The temperature may be at least 150° C. In some embodiments, the temperature is about 140° C. to about 200° C., about 150° C. to about 180° C., or about 150° C. to about 160° C. In some embodiments, the method includes disposing the polyamic acid on a surface of an article prior to the heating.

The various “contacting” steps of the methods described herein may occur in any suitable liquids. In some embodiments, the liquid is a polar liquid, an aprotic liquid, or a polar aprotic liquid.

The following non-limiting embodiments are provided as further examples:

Embodiment 1. A polymer or compound including one or more monomers of formula (I), a structure of formula (A), or a structure of formula (B); wherein R¹, R², R³, R⁴, and R⁶, independently, are a C₁-C₃₀ hydrocarbyl; R⁷ is a monocyclic or polycyclic C₁-C₃₀ hydrocarbyl; m is an integer from 2 to 1,000,000, 2 to 750,000, 2 to 500,000, 2 to 250,000, 2 to 100,000, or 2 to 10,000; n, p, and q, independently, are 0 or 1; and r is an integer from 0 to 6.

Embodiment 2. The polymer or compound of Embodiment 1, wherein R¹ is an unsubstituted oxy-diphenyl, and the polymer comprises one or more monomers of formula (Ia).

Embodiment 3. The polymer or compound of Embodiment 1 or 2, wherein p is 1, R² is an oxygen-substituted C₁ hydrocarbyl having the structure—OCH₂—, R³ is an unsubstituted aryl C₆ hydrocarbyl, n is 1, R⁴ is an unsubstituted C₁ hydrocarbyl, and the polymer comprises one or more monomers of formula (Ib).

Embodiment 4. The polymer or compound of any one of Embodiments 1 to 3, wherein R¹ is an unsubstituted or substituted oxy-diphenyl.

Embodiment 5. The polymer or compound of any one of Embodiments 1 to 4, wherein R¹ is an unsubstituted oxy-diphenyl, and the polymer comprises one or more monomers of formula (Ic).

Embodiment 6. The polymer or compound of any one of Embodiments 1 to 5, wherein R¹ is an unsubstituted oxy-diphenyl, and the polymer comprises one or more monomers of formula (Id).

Embodiment 7. The polymer or compound of any one of Embodiments 1 to 6, wherein q is 1, r is 1, and R⁶ is a tris(4-methoxyphenyl)methane moiety, and the compound has a structure of formula (Aa).

Embodiment 8. The polymer or compound of any one of Embodiments 1 to 7, wherein q is 1, r is 0, R⁷ is an unsubstituted C₆ hydrocarbyl, R⁶ is a C₂ hydrocarbyl comprising an ester moiety, and the compound has a structure of formula (Ba).

Embodiment 9. The polymer or compound of any one of Embodiments 1 to 8, wherein R¹ has a structure according to any of formulas (a)-(x) described herein.

Embodiment 10. A polyimide including one or more of the polymers or compounds of Embodiments 1 to 9.

Embodiment 11. A polyimide of formula (II), formula (III), or formula (IV); wherein R¹, R², R³, R⁴, and R⁶, independently, are a C₁-C₃₀ hydrocarbyl; R⁵ and R⁷, independently, are a monocyclic or polycyclic C₁-C₃₀ hydrocarbyl; m is an integer from 2 to 1,000,000, 2 to 750,000, 2 to 500,000, 2 to 250,000, 2 to 100,000, or 2 to 10,000; n, p, and q, independently, are 0 or 1; and r is an integer from 0 to 6.

Embodiment 12. The polyimide of Embodiment 11, wherein p is 1, R² is an oxygen-substituted C₁ hydrocarbyl having the structure—OCH₂—, R³ is an unsubstituted aryl C₆ hydrocarbyl, n is 1, R⁴ is an unsubstituted C₁ hydrocarbyl, and the polymer comprises one or more monomers of formula (IIa).

Embodiment 13. The polyimide of Embodiment 11 or 12, wherein R¹ is (i) an unsubstituted or substituted oxy-diphenyl, or (ii) has a structure according to any of formulas (a)-(x) described herein.

Embodiment 14. The polyimide of any one of Embodiments 11 to 13, wherein R⁵ is selected from the group consisting of (i) an unsubstituted benzene moiety; (ii) an unsubstituted biphenyl moiety; (iii) an unsubstituted benzophenonyl moiety; (iv) an unsubstituted oxy-diphenyl moiety; and (v) an unsubstituted naphthalenyl moiety.

Embodiment 15. An article having a surface on which a polyimide of any one of Embodiments 11 to 14 is disposed.

Embodiment 16. A wire including a conductor; and at least one layer of a polymeric enamel insulation adjacent the conductor, the polymeric enamel insulation including the polyimide of any one of Embodiments 11 to 14.

Embodiment 17. A method of forming a polyimide of any one of Embodiments 11 to 14.

Embodiment 18. A method of forming a polyimide, the method including providing (i) a polymer including a first monomer, the first monomer comprising a 2-((amino-C₁-C₃₀ hydrocarbyl)amino)ethan-1-olyl moiety, or (ii) a compound including two or more 2-((amino-C₁-C₃₀ hydrocarbyl)amino)ethan-1-olyl moieties; contacting (a) the polymer or the compound and (b) a dianhydride to form a polyamic acid; and heating the polyamic acid at a temperature effective to form the polyimide.

Embodiment 19. The method of Embodiment 18, wherein the providing of the polymer or the compound includes providing a precursor polymer or a precursor compound, respectively, the precursor polymer including a monomer including an epoxy moiety, and the precursor compound including two or more epoxy moieties; and contacting (i) the precursor polymer or the precursor compound and (ii) a diamine to form the polymer.

Embodiment 20. The method of Embodiment 19, wherein the precursor polymer comprises a novolac epoxy resin.

Embodiment 21. The method of Embodiment 20, wherein the novolac epoxy resin comprises one or more monomers of the following formula:

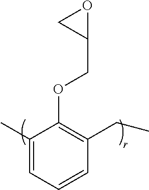

wherein r is an integer from 1 to 100.

Embodiment 22. The method of Embodiment 20, wherein the novolac epoxy includes dicyclopentadiene linkages, such as the following example of a novoloc epoxy:

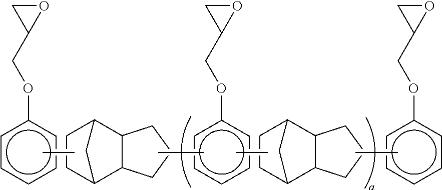

Embodiment 23. The method of any one of Embodiments 18 to 22, wherein the precursor compound or the precursor polymer is selected from a diepoxy, such as those described herein.

Embodiment 24. The method of any one of Embodiments 18 to 23, wherein the precursor compound includes a triepoxy.

Embodiment 25. The method of Embodiment 24, wherein the triepoxy includes a tri-phenyl core.

Embodiment 26. The method of any one of Embodiments 18 to 25, wherein the precursor compound includes a tetraepoxy.

Embodiment 27. The method of Embodiment 26, wherein the tetraepoxy includes a tetra-phenyl core.

Embodiment 28. The method of any one of Embodiments 18 to 27, wherein the precursor polymer is contacted with a molar excess of the diamine.

Embodiment 29. The method of any one of Embodiments 18 to 28, wherein the diamine is oxydianiline.

Embodiment 30. The method of any one of Embodiments 18 to 28, wherein the dianhydride is selected from the group consisting of (i) 1H,3H-benzo[1,2-c:4,5-c′]difuran-1,3,5,7-tetraone; (ii) [5,5′-biisobenzofuran]-1,1′,3,3′-tetraone; (iii) 5,5′-carbonylbis(isobenzofuran-1,3-dione); (iv) 5,5′-oxybis(isobenzofuran-1,3-dione); and (v) isochromeno[6,5,4-deflisochromene-],3,6,8-tetraone.

As used herein, the term “polymer” includes any compound having a structure that includes one or more monomers, wherein the monomers are the same or different. Therefore, the term “polymer”, as used herein, includes oligomers, homopolymers, and copolymers (i.e., polymers including at least two different monomers, including block copolymers, alternating copolymers, combinations thereof, etc.), and the polymers may have any structural arrangement, including, but not limited to, linear, branched, comb, star, or the like. The polymers also may be crosslinked.

When used herein with regard to the selection of a substituent, the term “independently” indicates that (i) a substituent at a particular location may be the same or different for each molecule or monomer of a formula (e.g., (i) a copolymer of formula (I) may include two molecules of formula (I), with each molecule having the same or a different C₁-C₃₀ hydrocarbyl selected for R¹; or (ii) a copolymer of formula (I) may include two monomers of formula (I), with each monomer have the same or a different C₁-C₃₀ hydrocarbyl selected for R¹), and/or (ii) two differently labeled substituents selected from the same pool of substituents may be the same or different (e.g., R¹ and R² of a molecule or monomer may both be selected from “a C₁-C₃₀ hydrocarbyl”, and the C₁-C₃₀ hydrocarbyls selected for R¹ and R² may be the same or different). The phrases “C₁-C₃₀ hydrocarbyl,” and the like, as used herein, generally refer to aliphatic, aryl, or arylalkyl groups containing 1 to 30 carbon atoms, including substituted derivatives thereof. Examples of aliphatic groups, in each instance, include, but are not limited to, an alkyl group, a cycloalkyl group, an alkenyl group, a cycloalkenyl group, an alkynyl group, an alkadienyl group, a cyclic group, and the like, and includes all substituted, unsubstituted, branched, and linear analogs or derivatives thereof, in each instance having 1 to 30 carbon atoms. Examples of alkyl groups include, but are not limited to, methyl, ethyl, propyl, isopropyl, n-butyl, t-butyl, isobutyl, pentyl, hexyl, isohexyl, heptyl, 4,4-dimethylpentyl, octyl, 2,2,4-trimethylpentyl, nonyl, decyl, undecyl and dodecyl. Cycloalkyl moieties may be monocyclic or multicyclic, and examples include cyclopropyl, cyclobutyl, cyclopentyl, cyclohexyl, and adamantyl. Additional examples of alkyl moieties have linear, branched and/or cyclic portions (e.g., 1-ethyl-4-methyl-cyclohexyl). Representative alkenyl moieties include vinyl, allyl, 1-butenyl, 2-butenyl, isobutylenyl, 1-pentenyl, 2-pentenyl, 3-methyl-1-butenyl, 2-methyl-2-butenyl, 2,3-dimethyl-2-butenyl, 1-hexenyl, 2-hexenyl, 3-hexenyl, 1-heptenyl, 2-heptenyl, 3-heptenyl, 1-octenyl, 2-octenyl, 3-octenyl, 1-nonenyl, 2-nonenyl, 3-nonenyl, 1-decenyl, 2-decenyl and 3-decenyl. Representative alkynyl moieties include acetylenyl, propynyl, 1-butynyl, 2-butynyl, 1-pentynyl, 2-pentynyl, 3-methyl-1-butynyl, 4-pentynyl, 1-hexynyl, 2-hexynyl, 5-hexynyl, 1-heptynyl, 2-heptynyl, 6-heptynyl, 1-octynyl, 2-octynyl, 7-octynyl, 1-nonynyl, 2-nonynyl, 8-nonynyl, 1-decynyl, 2-decynyl and 9-decynyl. Examples of aryl or arylalkyl moieties include, but are not limited to, anthracenyl, azulenyl, biphenyl, fluorenyl, indan, indenyl, naphthyl, phenanthrenyl, phenyl, 1,2,3,4-tetrahydro-naphthalene, anthracenyl, tolyl, xylyl, mesityl, benzyl, and the like, including any heteroatom substituted derivative thereof.

Unless otherwise indicated, the term “substituted,” when used to describe a chemical structure or moiety, refers to a derivative of that structure or moiety wherein (i) a multi-valent non-carbon atom (e.g., oxygen, nitrogen, sulfur, phosphorus, etc.) is bonded to one or more carbon atoms of the chemical structure or moiety (e.g., a “substituted” C₄ hydrocarbyl may include, but is not limited to, diethyl ether moiety, a methyl propionate moiety, an N,N-dimethylacetamide moiety, a butoxy moiety, etc., and a “substituted” aryl C₁₂ hydrocarbyl may include, but is not limited to, an oxydibenzene moiety, a benzophenone moiety, etc.) or (ii) one or more of its hydrogen atoms (e.g., chlorobenzene may be characterized generally as an aryl C₆ hydrocarbyl “substituted” with a chlorine atom) is substituted with a chemical moiety or functional group such as alcohol, alkoxy, alkanoyloxy, alkoxycarbonyl, alkenyl, alkyl (e.g., methyl, ethyl, propyl, t-butyl), alkynyl, alkylcarbonyloxy (—OC(O)alkyl), amide (—C(O)NH-alkyl-or -alkylNHC(O)alkyl), tertiary amine (such as alkylamino, arylamino, arylalkylamino), aryl, aryloxy, azo, carbamoyl (—NHC(O)O-alkyl- or —OC(O)NH-alkyl), carbamyl (e.g., CONH₂, as well as CONH-alkyl, CONH-aryl, and CONH-arylalkyl), carboxyl, carboxylic acid, cyano, ester, ether (e.g., methoxy, ethoxy), halo, haloalkyl (e.g., —CCl₃, —CF₃, —C(CF₃)₃), heteroalkyl, isocyanate, isothiocyanate, nitrile, nitro, oxo, phosphodiester, sulfide, sulfonamido (e.g., SO₂NH₂), sulfone, sulfonyl (including alkylsulfonyl, arylsulfonyl and arylalkylsulfonyl), sulfoxide, thiol (e.g., sulfhydryl, thioether) or urea (—NHCONH-alkyl-).

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of various embodiments, applicants in no way disclaim these technical aspects, and it is contemplated that the present disclosure may encompass one or more of the conventional technical aspects discussed herein.

The present disclosure may address one or more of the problems and deficiencies of known methods and processes. However, it is contemplated that various embodiments may prove useful in addressing other problems and deficiencies in a number of technical areas. Therefore, the present disclosure should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

In the descriptions provided herein, the terms “includes,” “is,” “containing,” “having,” and “comprises” are used in an open-ended fashion, and thus should be interpreted to mean “including, but not limited to.” When articles, compositions of matter, or methods are claimed or described in terms of “comprising” various steps or components, the devices, systems, or methods can also “consist essentially of” or “consist of” the various steps or components, unless stated otherwise.

The terms “a,” “an,” and “the” are intended to include plural alternatives, e.g., at least one. For instance, the disclosure of “an olefin”, “a copolymer”, and the like, is meant to encompass one, or mixtures or combinations of more than one olefin, copolymer, and the like, unless otherwise specified.

Various numerical ranges may be disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Moreover, all numerical end points of ranges disclosed herein are approximate. As a representative example, Applicant discloses, in some embodiments, that a temperature is “about 150° C. to about 160° C.”. This range should be interpreted as encompassing about 150° C. and about 160° C., and further encompasses “about” each of 151° C., 152° C., 153° C., 154° C., 155° C., 156° C., 157° C., 158° C., or 159° C., including any ranges and sub-ranges between any of these values.

As used herein, the term “about” means plus or minus 10% of the numerical value of the number with which it is being used.

### EXAMPLES

The present invention is further illustrated by the following examples, which are not to be construed in any way as imposing limitations upon the scope thereof. On the contrary, it is to be clearly understood that resort may be had to various other aspects, embodiments, modifications, and equivalents thereof which, after reading the description herein, may suggest themselves to one of ordinary skill in the art without departing from the spirit of the present invention or the scope of the appended claims. Thus, other aspects of this invention will be apparent to those skilled in the art from consideration of the specification and practice of the invention disclosed herein.

### Example 1— Synthesis of Polymer

In this example, 1600 g of N-methyl-2-pyrrolidone (NMP), 200.1 g (2.0 amine eq.) of oxydianiline (ODA), and 38.0 g (0.2 eq. epoxy) of ARALDITE® GY 289 Novolac epoxy (Huntsman, USA)(functionality of 2.2) were mixed in a 3 liter round bottom flask fitted with mechanical stirrer, N₂ inlet, and thermocouple.

This mixture was stirred and heated to 100° C. under a nitrogen blanket for 8 hours before cooling to room temperature. Then, 196.3 g of pyromellitic dianhydride (PMDA) (1.8 anhydride eq.) was added in three separate, equal portions, and, due to the observed exotherm, the mixture was allowed to cool to about 24° C. between additions. After all of the PMDA had been added, the mixture was stirred for 2 more hours. The mixture was then filtered, and produced a final enamel of 1550 cP viscosity at 30° C., and a polymer content of 19.5%.

### Example 2— Synthesis of Polymer

In this example, 1600 g NMP, 200.1 g (2.0 amine eq.) of ODA, and 46.8 g (0.2 eq. epoxy) TACTIX® 556 dicyclopentadiene Novolac epoxy (Huntsman, USA) were mixed in a 3 liter round bottom flask fitted with mechanical stirrer, N₂ inlet, and thermocouple. This mixture was stirred and heated to 100° C. under a nitrogen blanket for 6 hours. The mixture was then cooled to room temperature.

Then, 196.3 g of PMDA (1.8 anhydride eq.) was added in three separate, equal portions, and, due to the observed exotherm, the mixture was allowed to about 24° C. between additions. After all the PMDA had been added, the mixture was stirred for 2 additional hours. The solution was then filtered to produce a final enamel having a viscosity of 3100 cP at 30° C., and a polymer content of 20.0%.

### Example 3— Synthesis of Polymer

In this example, 1500 g NMP, 200.1 g (2.0 amine eq.) of ODA, and 32.0 g (0.2 eq. epoxy) TACTIX® 742 triphenylmethane based epoxy (Hunstman, USA) were mixed in a 3 liter round bottom flask fitted with a mechanical stirrer, N₂ inlet, and thermocouple. This mixture was stirred and heated to 100° C. under a nitrogen blanket for 6 hours. The mixture was then cooled to room temperature.

Then, 196.3 g of PMDA (1.8 anhydride eq.) were added in three separate, equal portions, and, due to the observed exotherm, the mixture was allowed to cool back to about 24° C. between additions. After all of the PMDA had been added, the mixture was stirred for 2 more hours. The solution was then filtered to produce a final enamel having a viscosity of 2100 cP at 30° C., and a polymer content of 20.0%.

1. A polyimide of formula (II), formula (III), or formula (IV): 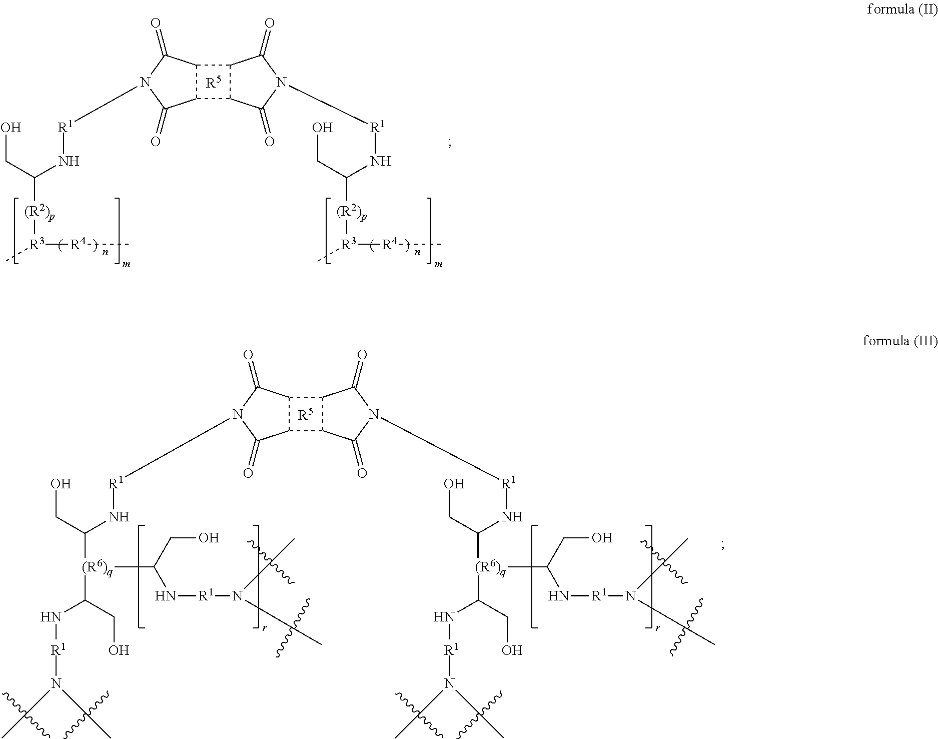 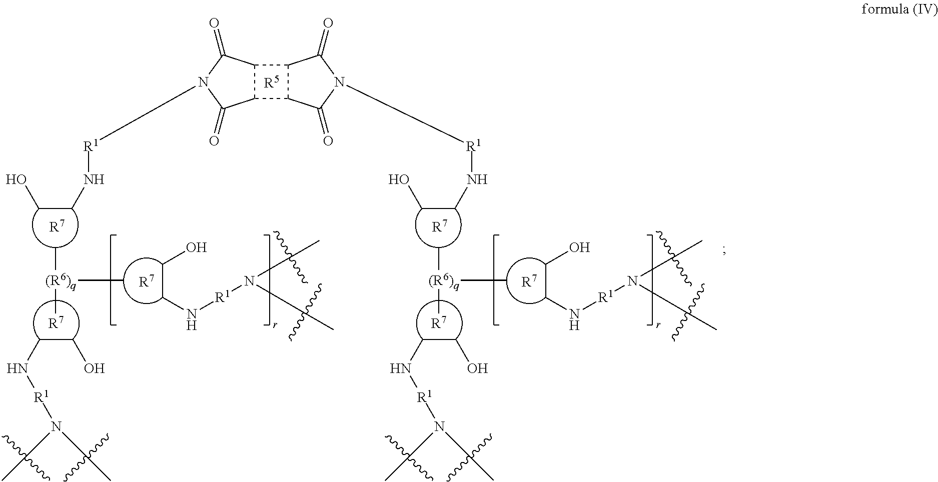
wherein-
R¹, R², R³, R⁴, and R⁶, independently, are a C₁-C₃₀ multivalent hydrocarbyl;
R⁵ and R⁷, independently, are a monocyclic or polycyclic C₁-C₃₀ multivalent hydrocarbyl;
m, in each instance, is independently selected from an integer from 2 to 10,000;
n, p, and q, independently, are 0 or 1; and
r is an integer from 0 to 6;
wherein when the polyimide is of formula (II), at least one R¹ is a non-aryl C₁-C₃₀ multivalent hydrocarbyl; and
wherein when the polyimide is of formula (III), r is an integer from 1 to 6.

2. The polyimide of claim 1, wherein p is 1, R² is an oxygen-substituted C₁ multivalent hydrocarbyl having the structure—OCH₂—, R³ is an unsubstituted aryl C₆ multivalent hydrocarbyl, n is 1, R⁴ is an unsubstituted C₁ multivalent hydrocarbyl, and the polymer comprises a structure according to formula (IIa):

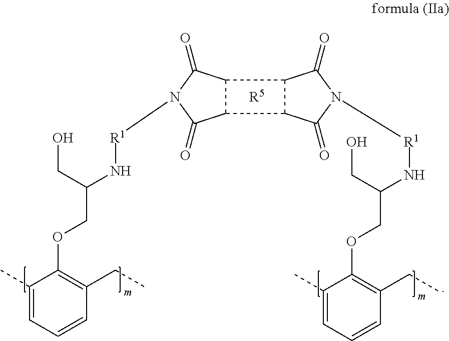

3. The polyimide of claim 2, wherein R¹ is an unsubstituted or substituted oxy-diphenyl.

4. The polyimide of claim 3, wherein R⁵ is selected from the group consisting of—

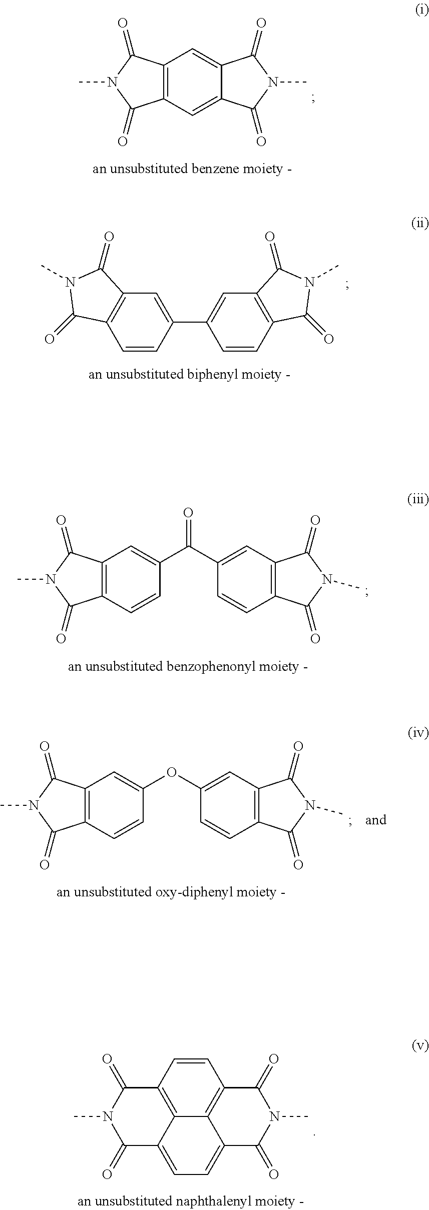

5. The polyimide of claim 1, wherein R₁ has a structure according to any of formulas (a)-(x):

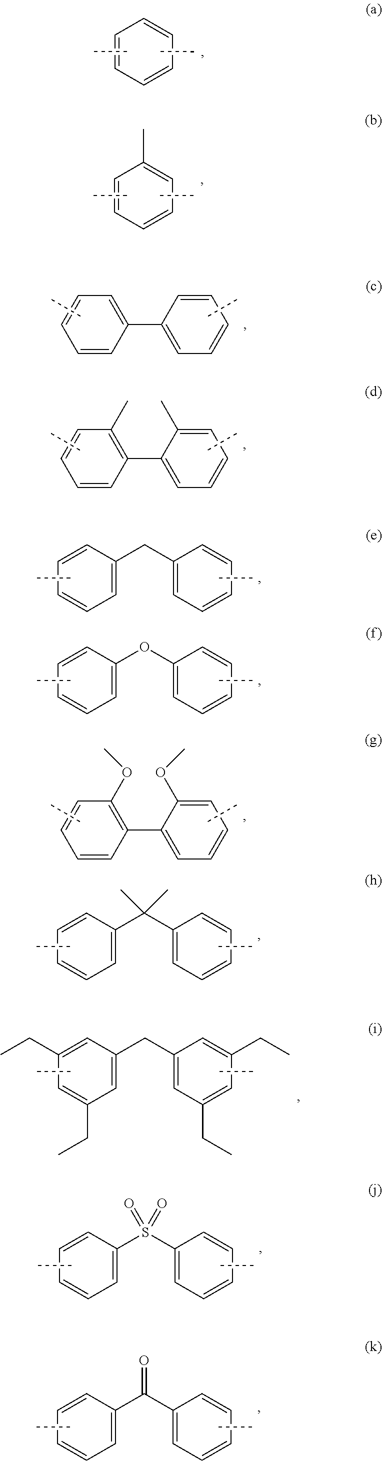

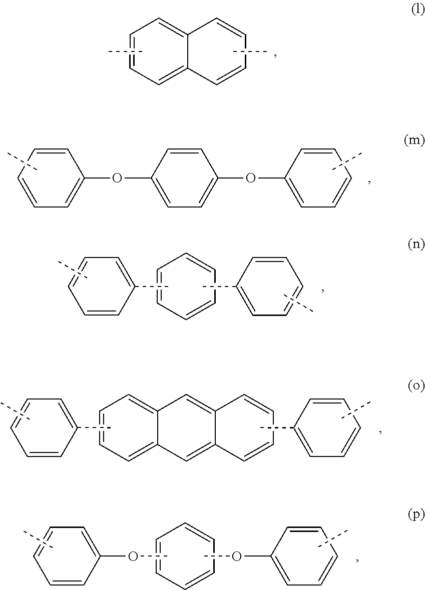

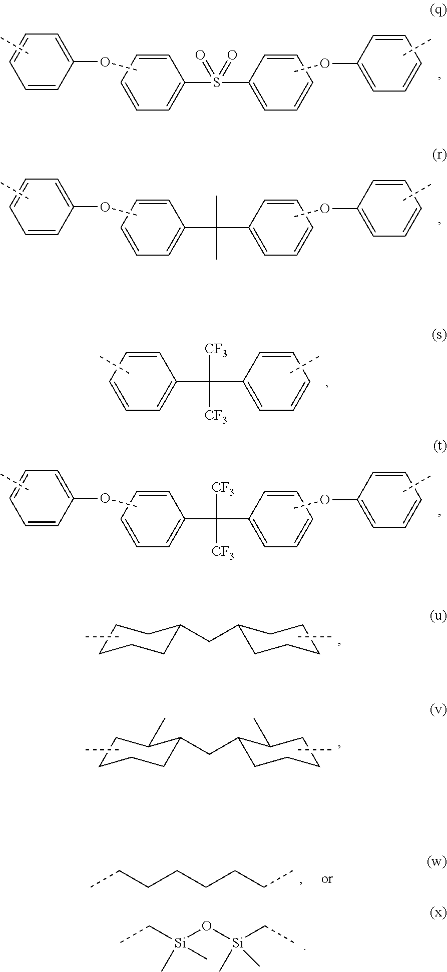

6. The polyimide of claim 1, wherein R⁵ is selected from the group consisting of—

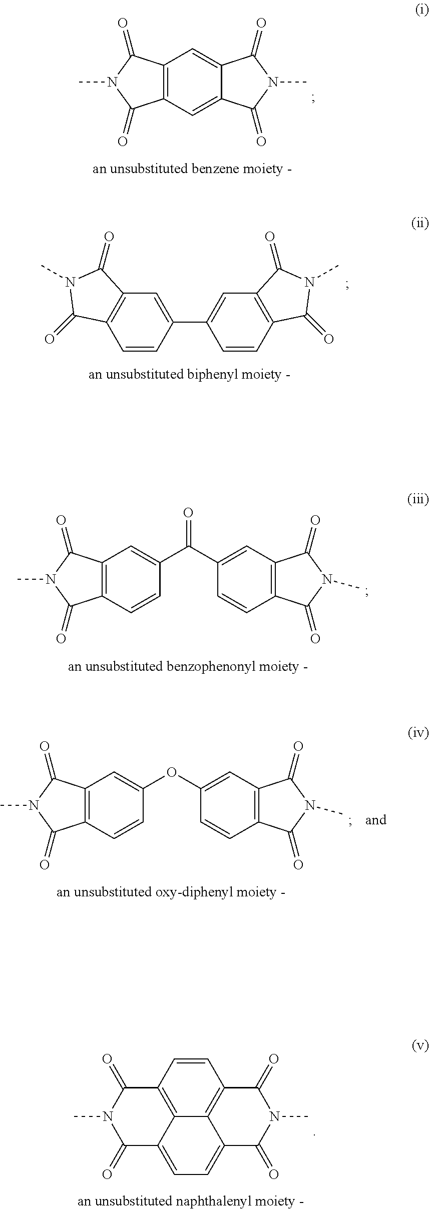

7. A wire comprising:
a conductor; and
at least one layer of a polymeric enamel insulation adjacent the conductor, the polymeric enamel insulation comprising the polyimide of claim 1.

8. The wire of claim 7, wherein the conductor comprises copper, aluminum, silver, gold, or an alloy.

9. The wire of claim 7, wherein the wire is a magnet wire.

10. A method of forming a polyimide, the method comprising:
providing (i) a polymer comprising a first monomer, the first monomer comprising a 2-((amino-C₁-C₃₀ hydrocarbyl)amino)ethan-1-olyl moiety, or (ii) a compound comprising two or more 2-((amino-C₁-C₃₀ hydrocarbyl)amino)ethan-1-olyl moieties;
contacting (a) the polymer or the compound and (b) a dianhydride to form a polyamic acid; and
heating the polyamic acid at a temperature effective to form the polyimide.

11. The method of claim 10, wherein the providing of the polymer or the compound comprises:
providing a precursor polymer or a precursor compound, the precursor polymer comprising a monomer comprising an epoxy moiety, and the precursor compound comprising two or more epoxy moieties;
contacting (i) the precursor polymer or the precursor compound and (ii) a diamine to form the polymer.

12. The method of claim 11, wherein the precursor polymer comprises a novolac epoxy resin.

13. The method of claim 12, wherein the novolac epoxy resin comprises one or more monomers of the following formula: 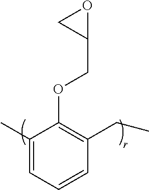
wherein r is an integer from 1 to 100.

14. The method of claim 11, wherein the precursor polymer is contacted with a molar excess of the diamine.

15. The method of claim 14, wherein the diamine is oxydianiline.

16. The method of claim 10, wherein the dianhydride is selected from the group consisting of

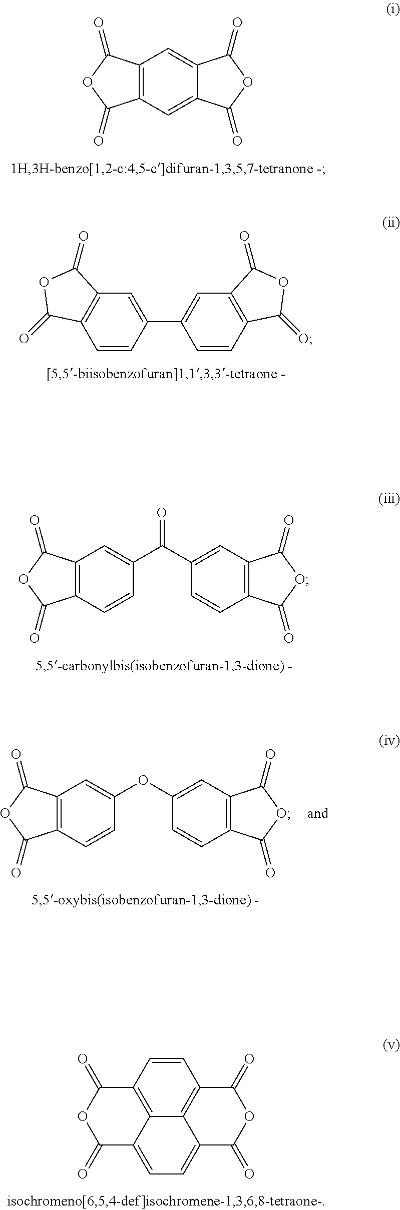 [SMILES: O=c1oc(=O)c2cc3c(=O)oc(=O)c3cc12 ; O=C1OC(=O)c2cc(-c3ccc4c(c3)C(=O)OC4=O)ccc21 ; O=C(c1ccc2c(c1)C(=O)OC2=O)c1ccc2c(c1)C(=O)OC2=O ; O=C1OC(=O)c2cc(Oc3ccc4c(c3)C(=O)OC4=O)ccc21 ; O=C1OC(=O)c2ccc3c4c(ccc1c24)C(=O)OC3=O]

17. A compound comprising a structure of formula (A), or a structure of formula (B): 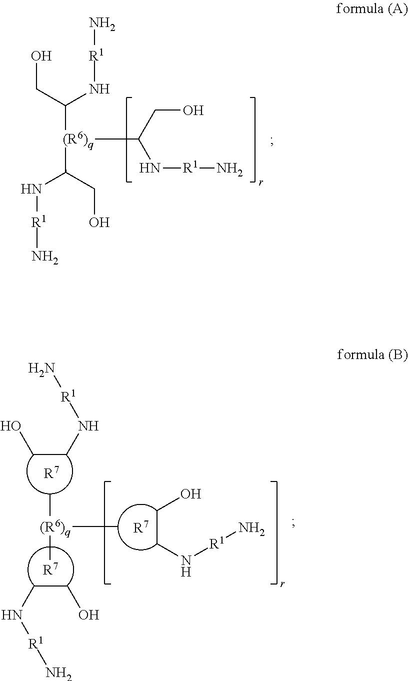
wherein-
R¹ and R⁶, independently, are a C₁-C₃₀ hydrocarbyl;
R⁷ is a monocyclic or polycyclic C₁-C₃₀ hydrocarbyl;
q is 0 or 1; and
r is an integer from 0 to 6.

18. The compound of claim 17, wherein R¹ is an unsubstituted or substituted oxy-diphenyl.

19. The compound of claim 17, wherein q is 1, r is 1, and R⁶ is a tris(4-methoxyphenyl)methane moiety, and the compound has a structure of formula (Aa):

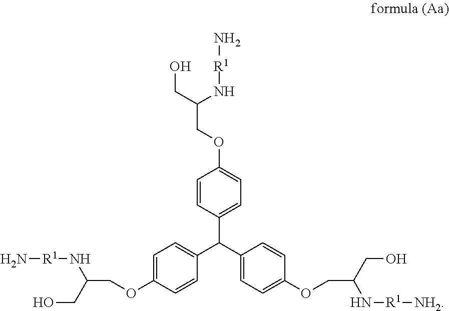

20. The compound of claim 17, wherein q is 1, r is 0, R⁷ is an unsubstituted monocyclic C₆ hydrocarbyl, R⁶ is a C₂ hydrocarbyl comprising an ester moiety, and the compound has a structure of formula (Ba): [chemical structure]
